(19) United States
(12) Patent Application Publication
(10) Pub. No.: US 2008/0030747 A1
(43) Pub. Date: Feb. 7, 2008

(54) Printing apparatus and printing method

(75) Inventor: Kosuke Shingai, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/888,767

(22) Filed: Aug. 2, 2007

(30) Foreign Application Priority Data
Aug. 2, 2006 (JP) 2006-210589

(51) Int. Cl. G06F 3/12

(52) U.S. Cl. 358/1.1

(57) ABSTRACT

The invention provides a printing apparatus that includes: an acquisition unit that acquires a file containing RAW image data, which is obtained by digitizing an image signal of a subject that is picked up by an image pickup device; an extraction unit that extracts, from the acquired file, a obtained image data, which is obtained by performing at least image compression processing on the RAW image data; a setting unit that sets printing condition of an image; a selection unit that selects either one of the RAW image data and the obtained image data on the basis of the printing condition that is set by the setting unit; and a printing unit that performs print processing by means of the image data selected by the selection unit.

### BACKGROUND

1. Technical Field

The present invention relates to a printing apparatus and a printing method.

2. Related Art

As a related art disclosed in JP-A-11-261933 (specifically, abstract and claims thereof), a digital camera that is capable of recording RAW image data, which is obtained by digitizing the signal of a subject image photographed by an image pickup device, into a storage medium is known.

A user sometimes experiences a long wait after issuance of a print command till its execution because, in order to generate printing data from RAW image data, it is necessary to perform pixel interpolation processing, density conversion processing, and spatial data conversion processing among other data processing based on photographing condition.

### SUMMARY

An advantage of some aspects of the invention is to provide a printing apparatus that shortens time taken after issuance of a command for the printing of RAW image data till its execution, and a printing method that offers the same advantage.

In order to achieve the above advantage, a printing apparatus according to an aspect of the invention includes: an acquisition section that acquires a file containing RAW image data, which is obtained by digitizing an image signal of a subject that is picked up by an image pickup device; an extraction section that extracts, from the acquired file, a obtained image data, which is obtained by RAW image data; a setting section that sets printing condition of an image; a selection section that selects either one of the RAW image data and the obtained image data on the basis of the printing condition that is set by the setting section; and a printing section that performs print processing by means of the image data selected by the selection section. Therefore, it is possible to provide a printing apparatus that shortens time taken after issuance of a command for printing the RAW image data till its execution.

In addition to the configuration of the printing apparatus according to the above-described aspect of the invention, it is preferable that the selection section selects the obtained image data when a normal plain paper is selected as a print target paper, whereas the selection section selects the RAW image data when other paper is selected as the print target paper. Advantageously, a user will not be dissatisfied with the quality of a printed image even when the obtained image data is used for printing because a normal plain paper does not offer a sufficient gradation. In addition, it is possible to reduce the waiting time after issuance of a printing instruction till its execution.

In addition to the configuration of the printing apparatus according to the above-described aspect of the invention, it is preferable that the selection section selects the RAW image data when the size of an image to be printed is larger than a predetermined size, whereas the selection section selects the obtained image data when the size of the image to be printed is not larger than the predetermined size. Therefore, it is possible to reduce the waiting time after issuance of a printing instruction till its execution by selecting the obtained image data when printing image(s) having a small size that makes it difficult for a user to visually recognize the quality of a printed image.

In addition to the configuration of the printing apparatus according to the above-described aspect of the invention, it is preferable that the selection section selects the RAW image data when the number of pixels of the obtained image data is not large enough in comparison with the number of pixels of the image to be printed, whereas the selection section selects the obtained image data when the number of pixels of the obtained image data is large enough in comparison with the number of pixels of the image to be printed. Therefore, it is possible to increase a print processing speed within a range of the obtained image data contained in the file.

In addition to the configuration of the printing apparatus according to the above-described aspect of the invention, it is preferable that the file contains a plurality of obtained image data each of which has a unique size different from that of others, and the selection section selects one obtained image data having an appropriate size in accordance with the size of the image to be printed. Therefore, it is possible to further increase a print processing speed by utilizing the obtained image data having a size suitable for a specific application/use.

In addition to the configuration of the printing apparatus according to the above-described aspect of the invention, it is preferable that the printing apparatus further includes a compensation section that performs, when the obtained image data is selected by the selection section, compensation processing on the obtained image data on the basis of both a development parameter that is used when generating the obtained image data from the RAW image data and another development parameter that is designated by a user for the RAW image data. Therefore, it is possible to obtain a printed image that is equivalent to one which is obtained by performing compensation processing on the RAW image data even when the obtained image data is used for printing.

In order to achieve the above advantage, a printing method according to another aspect of the invention includes the steps of: acquiring a file containing RAW image data, which is obtained by digitizing an image signal of a subject that is picked up by an image pickup device; extracting, from the acquired file, a obtained image data, which is obtained by performing at least image compression processing on the RAW image data; setting printing condition of an image; selecting either one of the RAW image data and the obtained image data on the basis of the printing condition that is set in the setting step; and performing print processing by means of the image data selected in the selection step. Therefore, it is possible to provide a printing method that shortens time taken after issuance of a command for printing the RAW image data till its execution.

### BRIEF DESCRIPTION OF THE DRAWINGS

The invention will be described with reference to the accompanying drawings, wherein like numbers reference like elements.

FIG. 1 is a block diagram that illustrates an example of the configuration of a printing apparatus according to the present embodiment of the invention.

FIG. 2 is a diagram that schematically illustrates an example of the configuration of a file stored in the memory card shown in FIG. 1.

FIG. 3 is a diagram that illustrates a functional block of the printing apparatus 11 illustrated in FIG. 1.

FIG. 4 is a flowchart that illustrates a series of processing performed by the printing apparatus 11 illustrated in FIG. 1.

### DESCRIPTION OF EXEMPLARY EMBODIMENTS

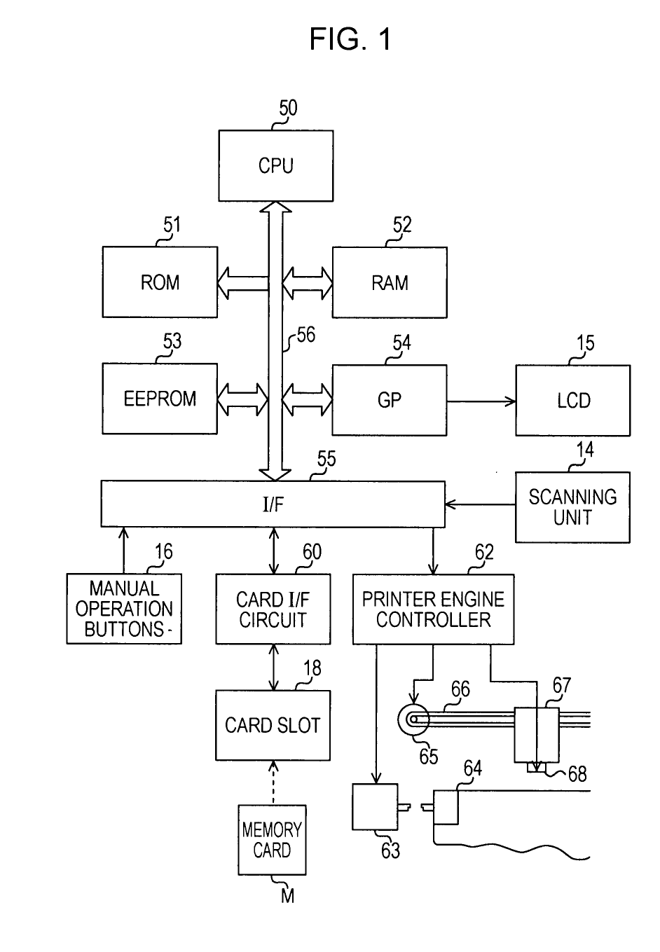

With reference to the accompanying drawings, an exemplary embodiment of the present invention is explained below. FIG. 1 is a block diagram that illustrates an example of the configuration of a printing apparatus according to the present embodiment of the invention. In the following description, the printing method according to the invention is explained as the operation of a printing apparatus 11.

The printing apparatus 11 illustrated in FIG. 1 is a so-called multitask (i.e., multifunction) printing apparatus that functions as a scanning apparatus, a printing apparatus, and a copying apparatus in a single unit configuration. The printing apparatus 11 is provided with a central processing unit (CPU) 50, a read only memory (ROM) 51, a random access memory (RAM) 52, an electrically erasable and programmable ROM (EEPROM) 53, a graphic processor (GP) 54, an interface (I/F) 55, a bus 56, an LCD 15, manual operation buttons 16, a card slot 18 into which a memory card M is inserted, a card I/F circuit 60, a printer engine controller 62, a paper feed motor 63, a roller 64, a carriage motor 65, a driving belt 66, a carriage 67, and a recording head 68.

The CPU 50 controls each of the functional components described above. Various programs to be executed by the CPU 50, without any limitation thereto, are stored in the ROM 51. The RAM 52 is used for storing programs and data temporarily. The EEPROM 53 is a data-rewritable ROM. The GP 54 performs picture-drawing processing to supply the obtained images to the LCD for display thereof.

The I/F 55 converts a data format into a suitable one. The bus 56 is a group of signal lines that allows information to be sent/received therebetween. The manual operation buttons 16 generate information in accordance with given user manipulation. The memory card M is a storage medium in which a file(s) containing RAW image data (hereafter referred to as “RAW image data file”) is stored.

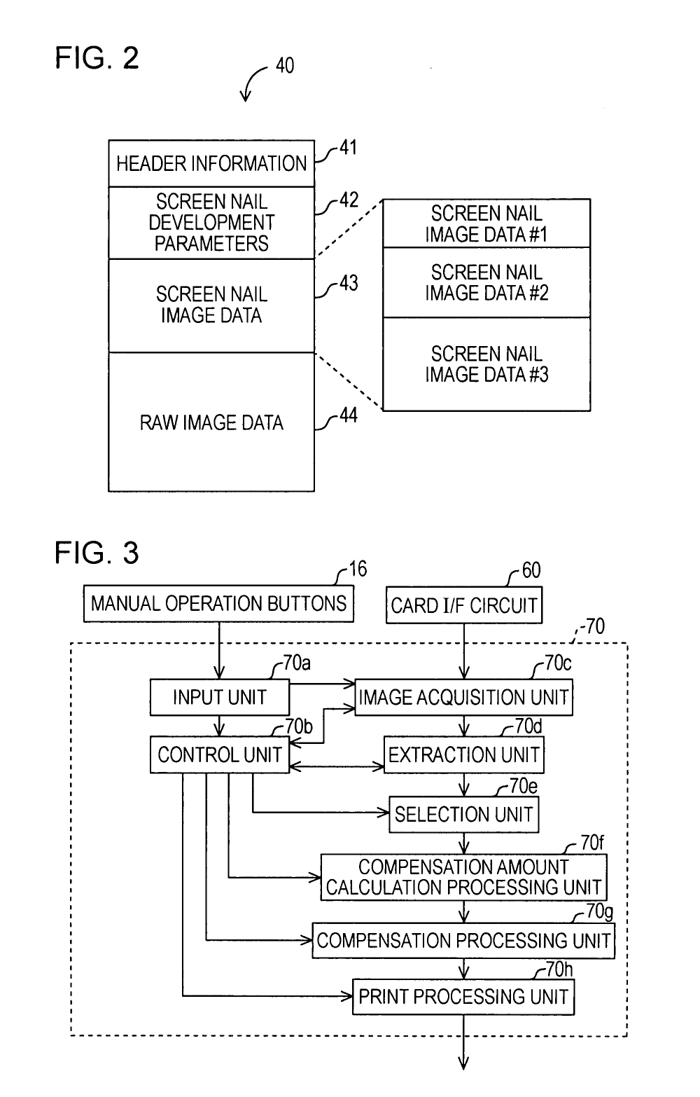

FIG. 2 is a diagram that schematically illustrates an example of the detailed configuration of the RAW image data file. As illustrated in FIG. 2, a RAW image data file 40 is made up of header information 41, “reduced-development” parameters 42, reduced image data (i.e., scaled-down image data. This is one kind of obtained image data.) 43, and RAW image data 44. The reduced image data 43, which is a collective concept, includes three pieces of reduced image data #1-#3, each of which has a unique data size different from the data size of the other two thereof. The header information 41 is information on a photographing condition at the time of image shooting (including but not limited to camera type, light exposure condition, and white balance). The reduced-development parameters (i.e., scaled-down development parameters) 42 are parameters that are used when generating the reduced image data 43 by developing (through data conversion) the RAW image data described below. The reduced-development parameters 42 include parameters related to, without any limitation thereto, interpolation processing, white balance processing, and color conversion processing. The reduced image data 43 is image data obtained by performing development processing on the RAW image data 44 using the reduced-development parameters 42. In this exemplary embodiment, the reduced image data 43 includes three types of image data, each of which varies from the other two thereof in terms of data size. Specifically, the reduced image data #1-#3 are constituted as quarter-size data, half-size data, full-size data of the RAW image data 44, respectively. The RAW image data 44 is digitized data of an image signal (for example, a Bayer-pattern/Bayer-array image signal) that is outputted from the image pickup device of a digital camera, which is not shown in the drawing.

Now referring back to FIG. 1 again, the card slot 18 is provided at a portion of the casing (i.e., chassis), which is not shown in the drawing, of the printing apparatus 11. The memory card M is inserted into the card slot 18. The card I/F circuit 60 functions as an interface for reading/writing data from/into the memory card M.

The printer engine controller 62 is a controlling unit that controls the paper feed motor 63, the carriage motor 65, and the recording head 68. The paper feed motor 63 transports a printing paper in the sub-scan direction by rotating the roller 64. The roller 64, which is made of a column-shaped member, moves the printing paper in the sub-scan direction. The carriage motor 65 reciprocates the carriage 67 in the main-scan direction by applying a driving force to the driving belt 66, one end of which is fastened to the carriage 67. Having a plurality of nozzles on a surface opposed to a printing paper, the recording head 68 records (i.e., prints) information on the printing paper by discharging color ink through the plurality of nozzles thereof.

FIG. 3 illustrates a functional block of the printing apparatus 11 illustrated in FIG. 1, where the illustrated functional block performs print processing of a designated RAW image data file 40 stored in the memory card M. The functional block 70 illustrated in FIG. 3 is implemented as a combination of software, that is, programs stored in the ROM 51 or the EEPROM 53 illustrated in FIG. 1, and hardware such as CPU 50 and the like, which function in cooperation with each other.

An input unit 70a illustrated in FIG. 3 accepts user input that is commanded through manual operation buttons 16. A control unit 70b, which functions as a specific example of a setting section, controls each functional unit on the basis of information transferred from the input unit 70a. An image acquisition unit 70c, which functions as a specific example of an acquisition section, acquires the designated RAW image data file from the memory card M. An extraction unit 70d, which functions as a specific example of an extraction section, extracts individual data components that make up the acquired RAW image data file 40. A selection unit 70e, which functions as a specific example of a selection section, selects either one of the reduced image data 43 and the RAW image data 44 as print target image data. In addition, if the reduced image data 43 is selected, the selection unit 70e further selects an appropriate piece of data among a plurality of pieces of reduced image data each of which has a unique data size different from that of others. A compensation amount calculation processing unit 70f, which constitutes one part of a compensation section as a specific partial example thereof, computes the amount of compensation (i.e., the amount of correction) for the image data selected by the selection unit 70e. A compensation processing unit 70g, which constitutes the other part (or another part) of the compensation section as a specific partial example thereof, performs image compensation processing on the image data selected by the selection unit 70e on the basis of the amount of compensation calculated by the compensation amount calculation processing unit 70f. A print processing unit 70h, which functions as a specific example of a printing section, performs print processing by outputting the image data that has been subjected to compensation processing by the compensation processing unit 70g to the printer engine controller 62.

Next, the operation of the printing apparatus 11 according to the present embodiment of the invention is explained below.

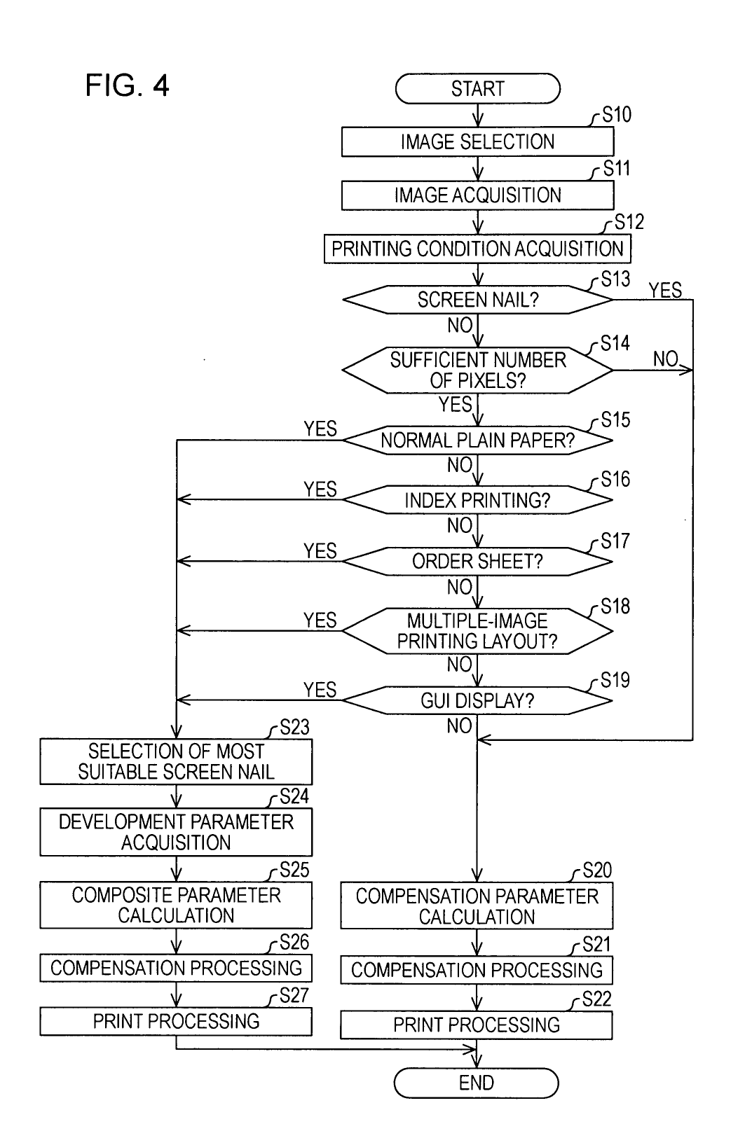

FIG. 4 is a flowchart that illustrates the operation of a printing apparatus according to an exemplary embodiment of the invention explained above with reference to FIG. 1. The print processing illustrated in the flowchart is initiated when the memory card M in which the RAW image data file(s) 40 illustrated in FIG. 2 is stored is inserted into the card slot 18 and then a user makes a request for printing the designated RAW image data file 40. The flowchart illustrates a series of judgment processing operations in which decisions are made as to whether the RAW image data 44, which is excellent in terms of the quality of a printed image although it requires a relatively long time for print processing, is chosen for print execution or the reduced image 43, which is excellent in terms of a relatively short time for print processing although it is inferior to the former in terms of the quality of a printed image, is chosen therefor. These decisions are made with reference to printing condition or the like. The entire judgment processing illustrated in the flowchart is initiated when a certain RAW image data file 40 stored in the memory card M is selected and printing thereof is instructed. Upon the start of the processing illustrated in this flowchart, the following steps are carried out.

Step S10: Firstly, the control unit 70b acquires, via the input unit 70a, information that is inputted through the manual operation buttons 16, and then makes a judgment as to whether a user has now selected a certain image (the RAW image data file 40) stored in the memory card M or not. For execution of this step, it may be configured that the file names of the RAW image data files 40 stored in the memory card M are displayed on the LCD 15 as a list or that the icons or the like of the reduced image data 43 contained in the RAW image data files 40 are displayed on the LCD 15 as a list in such a manner that a user is allowed to select a file name or image data which they desire.

Step S11: The control unit 70b acquires, from the memory card M, the RAW image data file 40 corresponding to the file name or the image data selected in the step S10. Since the memory card M has a predefined readable data unit, the control unit 70b reads one data unit thereof at a time out of the memory card M, and then stores it into, for example, the RAM 52.

Step S12: The control unit 70b displays a menu window on the LCD 15 so as to accept the input of information on printing condition entered through the manual operation buttons 16. Specifically, it accepts the input of a user-desired printing mode selected among normal printing, multiple-image printing, index printing, and order-sheet printing. In addition, it accepts the input of user-desired printing paper, that is, either normal plain paper or special paper other than the normal plain paper. Further in addition, it accepts the detailed input of user-desired compensation (i.e., correction) such as color phase compensation, chroma (i.e., color saturation) compensation, brightness (i.e., luminosity) compensation, contrast compensation, sharpness compensation, and filter compensation. In addition to the above, it further accepts the user-designated gamma correction for each of R, G, and B. Herein, the term “normal printing” means a printing mode in which one image is printed on one sheet of printing paper. The term “multiple-image printing” means a printing mode in which a plurality of images are printed on one sheet of printing paper. The term “index printing” means a printing mode in which images stored in the memory card M and corresponding file names thereof are printed as a list. The term “order-sheet printing” means a printing mode in which a so-called “order sheet”, which is used for selection of a print target image(s) by means of a scanning unit 14, is printed. The “order sheet” is a printed sheet on which, for example, a plurality of images and check boxes are shown in one-to-one correspondence. A user puts a check mark with a pencil or the like in each of the check boxes corresponding to an image that they desire to print. The scanning unit 14 then reads the checked order sheet for order processing. This is how the order sheet is used for selection of a print target image(s). The term “normal plain paper” means paper that is not subjected to any paper surface processing. Normal plain paper is used, for example, as fax paper, copy paper, and the like. A few examples of special paper other than the normal plain paper include: ink-jet-printing paper, which is used by an ink-jet printer, and dedicated paper for photographic printing use, without any limitation thereto. Such special paper is subjected to a certain kind of paper-surface processing so that the paper takes ink well and that its color-forming property is enhanced.

Step S13: The control unit 70b judges whether the reduced image data 43 is contained in the components extracted from the RAW image data file 40 by the extraction unit 70d or not. If it is judged that the reduced image data 43 is not contained in the components extracted from the RAW image data file 40 by the extraction unit 70d, the process goes to step S20. If it is contained therein, the process goes to step S14. That is, if the reduced image data 43 is not contained in the components extracted from the RAW image data file 40 by the extraction unit 70d, there is no option other than to print the RAW image data 44. In that case, the process jumps to the step S20, which is a processing step for printing the RAW image data 44.

Step S14: The control unit 70b judges whether the number of pixels of the reduced image data 43 is sufficient for printing or not by comparing it with the number of pixels required for printing. For example, 1440×2160 pixels are necessary for printing with the resolution of 360 dpi (dots per inch) in an area of 4×6 inches. Accordingly, the control unit 70b calculates the required number of pixels on the basis of the print target area and resolution so as to judge whether the reduced image data 43 having pixels the number of which is not less than the calculated number of pixels required for printing is present or not. If it is judged that the reduced image data 43 having a sufficient number of pixels is present, the process goes to step S15. If not, the process jumps to the step S20. That is, if it is judged that the reduced image data 43 having a sufficient number of pixels is not present, it follows that the RAW image data 44 is used for printing. In that case, the process goes to the step S20. It should be noted that the process moves on to the step S15 if at least one of the reduced image data #1-#3 satisfies the above condition.

Step S15: The control unit 70b acquires information on the printing condition inputted in the aforementioned step S12, and then judges whether normal plain paper is selected as the print target paper or not. If it is judged that normal plain paper is selected as the print target paper, the process goes to step S23. If not, the process goes to step S16. That is, when normal plain paper is selected as the print target paper, the printed image does not offer a sufficient gradation in comparison with a case where dedicated paper for photographic printing is used. Therefore, it is difficult for a user to perceive the difference in quality (i.e., higher quality) even if the RAW image data 44 is used while taking extra time. Thus, when normal plain paper is selected as the print target paper, the process goes to the step S23, which is a processing step for printing the reduced image data 43.

Step S16: The control unit 70b makes reference to the printing condition set in the aforementioned step S12 so as to judge whether index printing has been designated by the user or not. If the index printing has been designated, the process goes to the step S23. If not, the process goes to step S17. That is, in the index printing in which a plurality of small-size images are printed on a sheet of paper, it is difficult for a user to visually recognize the difference in image quality, which makes it significantly less meaningful and useful to choose the RAW image data 44 while taking extra time for printing. Therefore, if the index printing has been designated, the process goes to the step S23, which is a processing step for printing the reduced image data 43.

Step S17: The control unit 70b makes reference to the printing condition set in the aforementioned step S12 so as to judge whether order-sheet printing has been designated by the user or not. If the order-sheet printing has been designated, the process goes to the step S23. If not, the process goes to step S18. That is, in the order-sheet printing in which a plurality of small-size images are printed on a sheet of paper, it is difficult for a user to visually recognize the difference in image quality, which makes it meaningless and useless to choose the RAW image data 44, which takes extra time for printing. In addition, an order-sheet is intended to be used for designation of some image data by a user, which means that the order sheet itself is rarely saved. Therefore, if the order-sheet printing is designated, the process goes to the step S23, which is a processing step for printing the reduced image data 43.

Step S18: The control unit 70b makes reference, again, to the printing condition set in the aforementioned step S12 so as to judge whether multiple-image printing has been designated by the user or not. If the multiple-image printing has been designated, and further if the number of images that are to be printed on a sheet of printing paper is, for example, 20 or greater, the process goes to the step S23. If not, the process goes to step S19. That is, in the multiple-image printing with the designated number of images to be printed on a sheet of paper being, for example, 20 or greater, it is difficult for a user to visually recognize the difference in image quality. This makes it meaningless and useless to choose the RAW image data 44, which takes extra time for printing. Therefore, in such a case, the process goes to the step S23, which is a processing step for printing the reduced image data 43.

S19: The control unit 70b judges whether the image data is to be displayed on the LCD 15 as, for example, graphical user interface (GUI) information or not. If the image data is to be displayed on the LCD 15 as GUI information, the process goes to the step S23. If not, the process goes to step S20. That is, when the image data is displayed on the LCD 15 as GUI information, because of the small size of the LCD 15 (and images displayed thereon), it is difficult for a user to visually recognize the difference in image quality. This makes it meaningless and useless to choose the RAW image data 44, which takes extra time for printing. Therefore, in such a case, the process goes to the step S23, which is a processing step for printing the reduced image data 43.

Step S20: The compensation amount calculation processing unit 70f calculates compensation parameters on the basis of user-designated compensation set in the aforementioned step S12. Specifically, the compensation amount calculation processing unit 70f calculates compensation parameters such as color phase, chroma, brightness, contrast, sharpness, gamma curve, and so on, on the basis of the user-designated compensation set in the step S12.

Step S21: The compensation processing unit 70g performs compensation processing on the RAW image data 44 selected by the selection unit 70e on the basis of the parameters calculated by the compensation amount calculation processing unit 70f in the previous step S20. Specifically, the compensation processing unit 70g performs interpolation processing on the Bayer-pattern RAW image data 44 for compensation of missing pixels in each component so as to generate three pieces of plain image data of R, G, and B. Then, the compensation processing unit 70g conducts white-balance adjustment on the obtained RGB three pieces of plain image data, and subsequently, performs other various kinds of compensation/correction processing. It should be noted that the detailed explanation of the various kinds of compensations is omitted here because they are known art.

Step S22: The print processing unit 70h supplies the image data subjected to the above compensation processing to the printer engine controller 62 for execution of printing. By this means, an image corresponding to the RAW image data 44 subjected to the above compensation processing is printed on the print target paper. Since the RAW image data has complete information without any data loss due to compression and other processing, and further has a wide dynamic range in pixel gradation, it is possible to obtain a printed image of a high quality.

Step S23: The selection unit 70e selects, out of the RAW image data file 40, one reduced image data 43 that has an appropriate number of pixels that is not less than the number of pixels required for printing. Specifically, the selection unit 70e selects, among the reduced image data #1-#3, one reduced image data that has an appropriate number of pixels that is not less than the number of pixels required for printing.

Step S24: The compensation amount calculation processing unit 70f acquires the reduced-development parameters 42 out of the RAW image data file 40.

Step S25: Next, the compensation amount calculation processing unit 70f calculates a composite compensation parameter based on both of the reduced-development parameter 42 and the compensation amount that was set in the aforementioned step S12. That is, since compensation processing (“pre-compensation”) has already been performed on the basis of the reduced-development parameter 42 when generating the reduced image data 43 from the RAW image data 44, the compensation amount calculation processing unit 70f sets a compensation parameter that cancels the pre-compensation so as to obtain a compensation amount equal to the user-designated compensation amount that is set in the aforementioned step S12. Then, compensation processing is performed on the reduced image data 43 on the basis of the resultant composite compensation parameter. It is possible thereby to obtain a printed image that is equivalent to one which is obtained by performing the compensations designated in the step 12 on the RAW image data 44.

The following is a specific example of the operation described above. It is assumed here that the contrast value was compensated by “+2” in accordance with the reduced-development parameter 42 when developing the reduced image data 43 from the RAW image data 44. It is further assumed that the user designates now the contrast value of “+6” as printing condition for the RAW image data 44. If the user-designated contrast value “+6” is applied without any adjustment, it follows that the reduced image data 43 is subjected to “+8” compensation, which is the sum of the development contrast compensation value of “+2” and the user-designated contrast compensation value of “+6”. In order to cancel the pre-compensation, the composite contrast compensation parameter is set as “+4” by subtracting the development parameter “+2” from the user-designated parameter “+6”. The remaining composite compensation parameters related to other parameters are calculated in the same manner as above.

Step S26: The compensation processing unit 70g performs compensation processing on the reduced image data 43 selected by the selection unit 70e on the basis of the composite compensation parameters calculated by the compensation amount calculation processing unit 70f in the previous step S25. Specifically, the compensation processing unit 70g performs decompression processing on the JPEG-compressed reduced image data 43 and then performs color conversion processing thereon. Thereafter, the compensation processing unit 70g performs compensation processing on the color-converted data on the basis of the composite compensation parameters.

Step S27: The print processing unit 70h supplies the image data subjected to the above compensation processing to the printer engine controller 62 for execution of printing. When GUI display is selected, the compensated image data is supplied to the GP 54 and then displayed on the LCD 15. By this means, it is possible to obtain a printed image that is equivalent to one which is obtained by performing the compensations designated in the aforementioned step 12 on the RAW image data 44. Since the reduced image data 43 has a smaller amount of data with no need for time-consuming interpolation and similar processing in comparison with the RAW image data 44, it is possible to perform print processing more speedily. Therefore, it is possible to reduce the waiting time after issuance of a printing instruction till its execution. In addition, a user will not be dissatisfied with the quality of a printed image even when the reduced image data 43 is selected for printing because the image size or the like of the reduced image data 43 is small.

According to an exemplary embodiment of the invention described above, the RAW image data 44 is selected under a printing condition in which a high-quality image is required, whereas the reduced image data 43 is selected under a printing condition in which a high-quality image is not required. Therefore, the invention allows optimal selection to be made depending on a specific printing condition.

In addition, according to the exemplary embodiment of the invention, since the composite compensation parameters are used for compensation processing when the reduced image data 43 is printed, it is possible to obtain a printed image that is equivalent to one which is obtained by performing compensation processing on the RAW image data 44 even when the reduced image data 43, which has already been subjected to pre-compensation in the development processing, is used for printing. Therefore, for example, a user can decide the compensation amount of the RAW image data 44 by referring to an image printed on the basis of the reduced image data 43.

It is needless to say that the exemplary embodiment of the invention described above merely illustrates a specific example without any intention to limit the scope of the invention. That is, the invention may be implemented in a variety of alterations, adaptations, variations, changes, modifications, improvements, etc. thereof. For example, although it is described in the above embodiment of the invention that the memory card M is inserted in the card slot 18 of the main chassis to read out the RAW image data file 40, the invention is not restricted to such a specific example of implementation. Alternatively, it may be configured that a digital camera that is not shown in the drawing is connected to the I/F 55, etc., by means of a cable that is also not shown in the drawing so as to allow the RAW image data file 40 to be read via the cable.

Moreover, although a multitask (i.e., integrated) printing apparatus is taken as an example for explanation in the above-described embodiment of the invention, the invention may be applied to a normal printing apparatus (i.e., a printing apparatus that is used in connection with a personal computer). Furthermore, it is also possible to apply the invention to an ordinary stand-alone type printing apparatus that is not a multitask/integrated one.

Still moreover, although it is described in the above embodiment of the invention that the printing apparatus 11 performs a series of processing illustrated in FIG. 4, as an example of alternative configurations, a host computer that is connected to the printing apparatus 11 may perform the illustrated processing instead of the printing apparatus 11.

Still furthermore, although it is described in the above embodiment of the invention that the reduced image data is used if the number of images that are to be printed on a sheet of paper is 20 or greater, a judgment threshold (in the above-described embodiment, 20) may be varied depending on the size of a print target paper. For example, it may be configured that the threshold is set at 20 when the size of the print target paper is A4, whereas it is set at 15 when the size thereof is A5.

Still moreover, although it is described in the above embodiment of the invention that either one of the reduced image data 43 and the RAW image data 44 is selected automatically depending on a printing mode, it may be configured that, for example, the LCD 15 displays a message that prompts the user to input their selection of either one thereof. In such an alternative configuration, printing is performed on the basis of the selected image data.

In the embodiment of the invention described above, composite compensation parameters are used for compensation processing with no exceptions as long as the reduced image data 43 is selected. However, it is reasonably expected that a user cannot visually recognize the enhanced quality of images subjected to composite compensation processing if the size of the printed images is small. Therefore, as an alternative configuration, the composite compensation processing may be skipped if the size of the printed images is small.

The entire disclosure of Japanese Patent Application No. 2006-210589, filed April Aug. 3, 2006 is expressly incorporated by reference herein.

What is claimed is:

1. A printing apparatus comprising:
an acquisition section that acquires a file containing RAW image data, which is obtained by digitizing an image signal of a subject that is picked up by an image pickup device;
an extraction section that extracts, from the acquired file, a obtained image data, which is obtained by the RAW image data;
a setting section that sets printing condition of an image;
a selection section that selects either one of the RAW image data and the obtained image data on the basis of the printing condition that is set by the setting section; and
a printing section that performs print processing by means of the image data selected by the selection section.

2. The printing apparatus according to claim 1, wherein the selection section selects the obtained image data when a normal plain paper is selected as a print target paper, whereas the selection section selects the RAW image data when other paper is selected as the print target paper.

3. The printing apparatus according to claim 1, wherein the selection section selects the RAW image data when the size of an image to be printed is larger than a predetermined size, whereas the selection section selects the obtained image data when the size of the image to be printed is not larger than the predetermined size.

4. The printing apparatus according to claim 1, wherein the selection section selects the RAW image data when the number of pixels of the obtained image data is not large enough in comparison with the number of pixels of the image to be printed, whereas the selection section selects the obtained image data when the number of pixels of the obtained image data is large enough in comparison with the number of pixels of the image to be printed.

5. The printing apparatus according to claim 1, wherein the file contains a plurality of obtained image data each of which has a unique size different from that of others, and the selection section selects one obtained image data having an appropriate size in accordance with the size of the image to be printed.

6. The printing apparatus according to claim 1, further comprising a compensation section that performs, when the obtained image data is selected by the selection section, compensation processing on the obtained image data on the basis of both a development parameter that is used when generating the obtained image data from the RAW image data and another development parameter that is designated by a user for the RAW image data.

7. A printing method comprising the steps of: acquiring a file containing RAW image data, which is obtained by digitizing an image signal of a subject that is picked up by an image pickup device;
extracting, from the acquired file, a obtained image data, which is obtained by performing at least image compression processing on the RAW image data;
setting printing condition of an image;
selecting either one of the RAW image data and the obtained image data on the basis of the printing condition that is set in the setting step; and
performing print processing by means of the image data selected in the selection step.
